(19) United States
(12) Patent Application Publication
(10) Pub. No.: US 2001/0022755 A1
(43) Pub. Date: Sep. 20, 2001

(54) Mixer system and method

(76) Inventors: Mark T. Holtzapple, College Station, TX (US); Salvador Aldrett Lee, Corpus Christi, TX (US); Edith R. Isbell, Bryan, TX (US)

Correspondence Address: James L. Baudino, Esq., Baker Botts L.L.P., 2001 Ross Avenue, Dallas, TX, 75201-2980, US

(21) Appl. No.: 09/741,363

(22) Filed: Dec. 19, 2000

Related U.S. Application Data
(60) Provisional application No. 60/171,672, filed on Dec. 20, 1999.

(51) Int. Cl. B01F 7/32

(52) U.S. Cl. 366/265; 261/87; 261/93

(57) ABSTRACT

A mixer for producing a substance mixture includes a rotatable shaft and a body submersible within a first substance. The body includes a first end and a second end. The first end is coupled to the shaft, and the second end includes an outwardly flared opening. The mixer also includes a plurality of apertures disposed on a wall of the body. Rotation of the body draws the first substance and a second substance into an internal area of the body and dispels the substance mixture outwardly through the apertures. The mixer may also include a diverter for diverting the substance mixture toward the apertures. The mixer may further include internally formed vanes to increase a substance flow rate into the mixer. Screens may also be disposed outwardly from the apertures to enhance mixing of the first and second substances.

### RELATED APPLICATIONS

This application claims the benefit of Ser. No. 60/171,672, entitled “Isbell Oxygenator,” filed provisionally on Dec. 20, 1999.

### TECHNICAL FIELD OF THE INVENTION

This invention relates in general to the field of substance mixing and, more particularly, to a mixer system and method.

### BACKGROUND OF THE INVENTION

Aerators, diffusers, and other mixing devices are generally used to rapidly and efficiently mix two or more substances together, such as, but not limited to, dissolving gases into liquids or mixing two or more immiscible liquids together for various applications. For example, many applications require the dissolution of large amounts of oxygen into a large volume of liquid, such as the oxygenation of commercial fishing ponds or the oxygenation of sewage or process water from industrial plants and mills to purify the liquid. To facilitate rapid dissolution of a gas into a liquid, large numbers of micro-bubbles of the gas are generally introduced into the liquid to increase the gas-liquid contact. Soluble gases are generally easily and rapidly dissolved into a liquid, especially under the application of pressure. However, the less soluble gases are more difficult to dissolve into a liquid economically and efficiently. Immiscible liquids, for example, may be mixed together to form stable emulsions or to enhance mass transfer in extraction processes.

One example of a mixing device includes a body having a closed top and an open bottom. The bottom may be in the form of a conical-shaped frustum or may be cylindrical in shape. A plurality of openings are disposed around the perimeter of the body near the closed top. The mixer is submerged in a liquid and rotated at relatively high speeds, thereby creating a centrifuge-pump. When the mixer is located near a surface of the liquid, gas near the surface of the liquid is introduced into a low-pressure internal area of the mixer. When the mixer is submerged substantially below the surface or if a gas other than oxygen is to be dissolved, the gas may be pumped into the open bottom of the mixer.

The mixer described above, however, generally requires relatively high rotational speeds to create the centrifuge-pump action. Thus, at relatively lower rotational speeds, the efficiency of the mixer is reduced. Additionally, minimum levels of gas dissolution still require relatively high rotational speeds, thereby increasing the amount of energy required to operate the mixer.

### SUMMARY OF THE INVENTION

Accordingly, a need has arisen for a mixer system and method that provides greater efficiency over a larger spectrum of operating parameters. The present invention provides an improved mixer system and method that addresses shortcomings and problems associated with prior mixer systems and methods.

According to one embodiment of the present invention, a mixer for producing a substance mixture includes a rotatable shaft and a body submersible within a first substance. The body includes a first end coupled to the shaft and a second end having an outwardly flared opening. The mixer also includes a plurality of apertures disposed on a wall of the body. Rotation of the body draws the first substance and a second substance into an internal area of the body and dispels the substance mixture outwardly through the apertures.

According to another embodiment of the present invention, a mixer for producing a substance mixture from a first substance and a second substance includes a first member having a closed first end and an open second end. The first member includes a plurality of openings disposed in an outer wall thereof. The mixer also includes a rotatable shaft coupled to the first end of the first member. The mixer also includes a second member having a first end and a second end. The first end of the second member is coupled to the second end of the first member. An outwardly flared opening is disposed on the second end of the second member. Rotation of the first and second members draws the first and second substances into an internal area of the first member and dispels the substance mixture outwardly through the apertures.

According to another embodiment of the present invention, a mixer for producing a substance mixture includes a rotatable shaft and a body submersible within a first substance. The body includes a first end coupled to the shaft and an open second end. The mixer also includes a cone disposed within an internal area of the body. The cone includes an apex directed downwardly toward the second end. The mixer further includes a plurality of apertures disposed on a wall of the body. Rotation of the body draws the first substance and a second substance into the internal area of the body and dispels the substance mixture outwardly through the apertures. The inverted cone is operable to divert the substance mixture toward the apertures.

According to yet another embodiment of the present invention, a mixer for producing a substance mixture includes a rotatable shaft and a body submersible within a first substance. The body includes a first end coupled to the shaft and a second end having an opening. The mixer also includes a plurality of apertures disposed on a wall of the body. Rotation of the body draws the first substance and a second substance into an internal area of the body and dispels the substance mixture outwardly through the apertures. The mixer further includes a screen disposed outwardly from the apertures and operable to enhance mixing of the first and second substances as the substance mixture passes through the screen.

According to yet another embodiment of the present invention, a mixer for producing a substance mixture includes a rotatable shaft and a body submersible within a first substance. The body includes a first end and an open second end. The first end of the body is coupled to the shaft. The mixer also includes a plurality of apertures disposed on a wall of the body. Rotation of the body draws the first substance and a second substance into an internal area of the body and dispels the substance mixture outwardly through the apertures. The mixer further includes a plurality of vanes disposed on an internal wall of the body between the apertures and the opening. The vanes are operable to enhance a flow rate into the internal area of the body.

The present invention provides several technical advantages. For example, according to one embodiment of the present invention, a plurality of vanes are disposed within an internal wall of a body to enhance a flow rate into the mixer. The vanes may be helically configured corresponding to a direction of rotation of the mixer. Thus, the present invention provides greater efficiency than prior mixer systems and methods by increasing the turn-down ratio of the device and increasing a substance or substance mixture flow rate into the internal area of the mixer at lower rotational speeds. Therefore, the present invention provides greater efficiency over a wider range of rotational speeds.

The present invention also provides a smoother and more efficient substance flow rate through the mixer than prior systems and methods. For example, according to one embodiment of the present invention, a diverter is disposed within an internal area of the mixer to divert a substance or a substance mixture drawn into an internal area of the mixer toward the apertures. According to one embodiment of the present invention, the diverter is configured as an inverted cone located within the mixer to divert the substance or substance mixture toward the apertures. According to another embodiment of the present invention, an outwardly flared opening is disposed at a lower end of the mixer to provide smoother substance flow patterns around and into the mixer.

The present invention also provides greater substance mixing than prior mixers. For example, according to one embodiment of the present invention, one or more screens may be disposed outwardly from the apertures to enhance substance mixing by passing the substance mixture through the screen as the substance mixture flows outwardly from the apertures. For example, in a gas-liquid dissolution application, one or more screens may be used to decrease a bubble size of a gas-liquid mixture as the gas-liquid mixture flows outwardly through the apertures, thereby providing greater gas surface area and increasing the gas-to-liquid contact.

Other aspects and technical advantages will be readily apparent to one skilled in the art from the following figures, descriptions and claims.

### BRIEF DESCRIPTION OF THE DRAWINGS

For a more complete understanding of the present invention and the advantages thereof, reference is now made to the following description taken in conjunction with the accompanying drawings, in which:

FIG. 1 is a diagram illustrating a mixer in accordance with an embodiment of the present invention;

FIG. 2 is a diagram illustrating a mixer in accordance with another embodiment of the present invention;

FIGS. 3A-3B are diagrams illustrating a mixer in accordance with another embodiment of the present invention;

FIGS. 4A-4B are diagrams illustrating a mixer in accordance with another embodiment of the present invention;

FIG. 5 is a diagram with portions broken away illustrating a mixer in accordance with another embodiment of the present invention;

FIGS. 6A-6B are diagrams illustrating a mixer system in accordance with another embodiment of the present invention;

FIG. 7 is a diagram illustrating a mixer system in accordance with another embodiment of the present invention; and

FIGS. 8A-8B are diagrams illustrating a mixer in accordance with another embodiment of the present invention;

FIG. 9 is a diagram illustrating a mixer in accordance with another embodiment of the present invention;

FIGS. 10A-10B are diagrams illustrating a mixer in accordance with another embodiment of the present invention; and

FIG. 11 is a diagram illustrating a mixer in accordance with another embodiment of the present invention.

### DETAILED DESCRIPTION OF THE INVENTION

FIG. 1 is a diagram illustrating a mixer 10 in accordance with an embodiment of the present invention. Mixer 10 may include an aerator, diffuser or other device for mixing, dissolving or otherwise blending two or more substances together, such as, but not limited to, a gas into a liquid, two or more immiscible liquids, or two or more multi-phase substances. The mixer 10 described below in connection with FIGS. 1 through 11 is illustrated and described corresponding to dissolving a gas into a liquid; however, it should be understood that mixer 10 may be used in other substance-mixing applications.

Referring to FIG. 1, mixer 10 includes a body 11 having an upper cylindrical member 12 coupled to a lower member 14. However, it should be understood that body 11 may also be formed as a single unit. An end 16 of member 12 is coupled to a rotatable shaft 18. Shaft 18 may be solid or may be hollow to provide a substance flow path as will be discussed below in greater detail. End 16 may be formed having an upwardly curved or rounded surface 20 or may have other suitable geometric configurations.

Member 12 also includes a plurality of spaced apart apertures 22 disposed in an outer wall 24 of member 12. In the illustrated embodiment, member 12 is symmetrically formed having a generally uniform diameter. In the illustrated embodiment, apertures 22 comprise circular openings 25 formed in wall 24; however, it should be understood that the apertures 22 may have other suitable geometric configurations. Wall 24 may comprise a screen or a portion of a screen such that a wire mesh forms the apertures 22 or wall 24 may comprise a solid structure having apertures 22 formed by drilling, punching or other suitable processes.

An upper end 26 of member 14 is formed having a diameter substantially equal to a diameter of a lower end 28 of member 12 such that members 12 and 14 may be coupled together to form a unit. A lower end 30 of member 14 includes an outwardly flared opening 32 for receiving a substance, such as a liquid or a gas-liquid mixture, into the mixer 10. For example, member 14 is constructed such that a diameter of member 14 at end 30 is greater than a diameter of member 14 at end 26 or at the intersection of members 12 and 14. In the illustrated embodiment, member 14 is formed having a substantially straight wall 34 extending downwardly from end 28 of member 12 to form a substantially straight outwardly flared opening 32. However, it should be understood that outwardly flared opening 32 may be configured having other suitable geometric configurations.

In operation, mixer 10 is disposed within a substance, such as a liquid. A rotational force is delivered to shaft 18, thereby causing mixer 10 to rotate while submerged within the liquid to create a centrifuge-pump. For example, rotation of mixer 10 forces a mixed substance, such as a liquid or a gas-liquid mixture, within an internal area 36 of member 12 outwardly through the apertures 22. As the liquid or gas-liquid mixture flows outwardly through the apertures, a vacuum pressure is created within the internal area 36, thereby drawing additional liquid or gas-liquid mixture upwardly through opening 32 into the internal area 36.

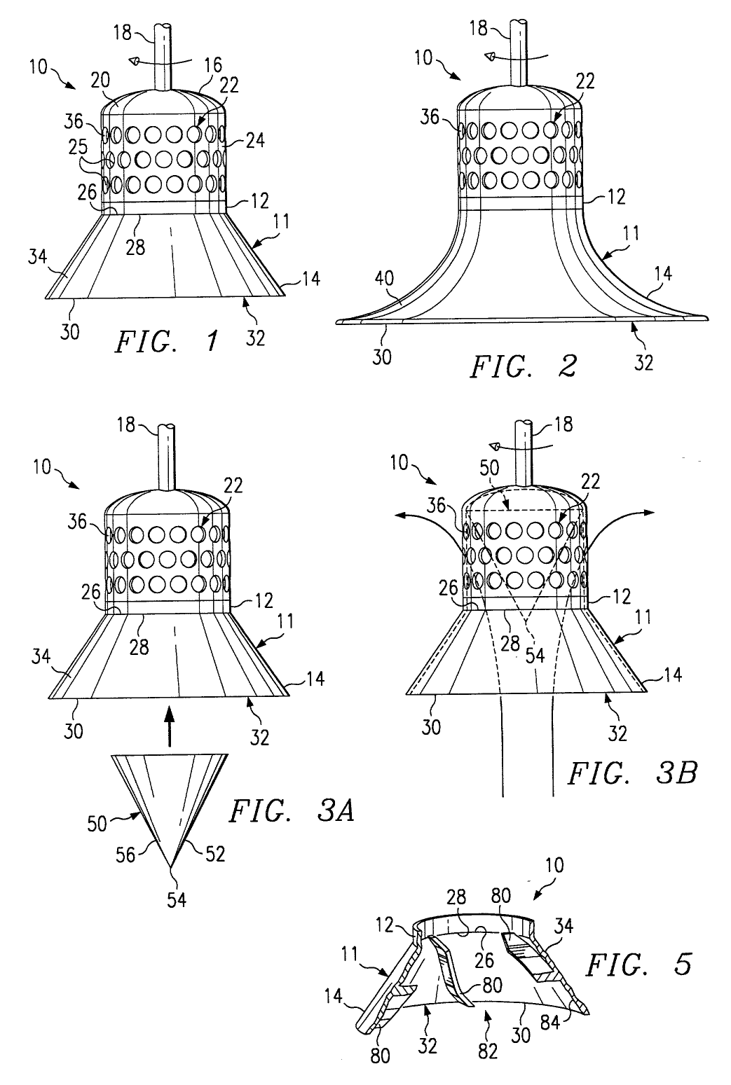

FIG. 2 is a diagram illustrating mixer 10 in accordance with another embodiment of the present invention. In this embodiment, member 14 includes a curved outwardly flared opening 32 formed by a curved wall 40 of member 14. For example, wall 40 may slope downwardly from end 26 to end 30 at a predetermined radius of curvature to provide a generally smooth substance flow pattern around the mixer 10 and into the internal area 36 of member 12. However, it should be understood that wall 40 may be formed having a parabolic or other suitable outwardly curving geometric configuration. Thus, as illustrated in FIGS. 1 and 2, the outwardly flared opening 32 of mixer 10 provides a smooth flow transition from areas adjacent to mixer 10 to the internal area 36 of mixer 10, thereby providing a more efficient flow pattern through mixer 10.

FIGS. 3A-3B are diagrams illustrating mixer 10 in accordance with another embodiment of the present invention. In this embodiment, a diverter 50 is disposed within internal area 36 of mixer 10 to divert the flow of the substance toward the apertures 22. In the illustrated embodiment, diverter 50 comprises an inverted cone 52 having an apex 54. Cone 52 is disposed within internal area 36 such that apex 54 is directed downwardly toward opening 32. As illustrated in FIGS. 3A-3B, cone 52 is constructed having a substantially linear outer wall 56; however, other suitable non-linear wall geometries may be used to form diverter 50, including, but not limited to, concave and/or convex wall geometries. Cone 52 is constructed having a downwardly extending length such that apex 54 of cone 52 is disposed at or below the lowest disposed aperture 22 such that substance flow diversion occurs as the substance flow enters the internal area 36 of member 12 corresponding to the apertures 22. Thus, in operation, the substance drawn upwardly within mixer 10 is diverted outwardly toward apertures 22 to provide a smoother flow pattern through mixer 10.

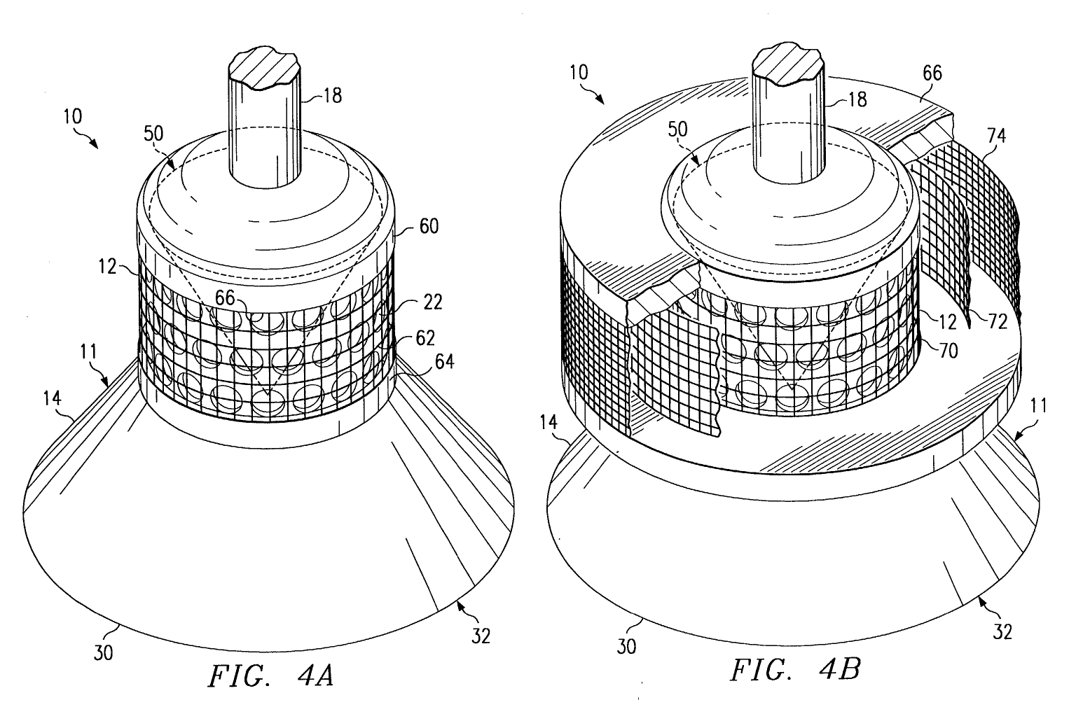

FIGS. 4A-4B are diagrams illustrating mixer 10 in accordance with another embodiment of the present invention. Referring to FIG. 4A, mixer 10 includes a screen 60 coupled to body 11 and disposed outwardly from apertures 22. Screen 60 may be disposed within a cavity 62 formed on an outwardly disposed surface 64 of member 12. However, screen 60 may be otherwise disposed and coupled to mixer 10 such that a substance mixture emerging from the apertures 22 flows outwardly through screen 60. In operation, screen 60 provides additional mixing of the substances. For example, in the case of a gas-liquid dissolution application, screen 60 breaks the gas bubbles contained within a gas-liquid mixture into smaller sizes, thereby increasing the surface area of bubbles within the gas-liquid mixture. The increased surface area of the bubbles thereby results in greater dissolution of the gas into the liquid.

Screen 60 is constructed having a generally rectangular mesh 66; however, it should be understood that screen 60 may be constructed having other suitable geometric configurations. A size of the mesh 66 is constructed generally smaller than a size of the apertures 22 such that the substance mixture emerging from the apertures 22 are forced through the smaller size mesh 66 to provide additional substance mixing. For example, in the case of a gas-liquid dissolution application, a size of the mesh 66 is constructed generally smaller than a size of the apertures 22 such that gas bubbles emerging from the apertures 22 are forced through the smaller mesh size 66 to decrease the bubble size of the gas-liquid mixture.

Referring to FIG. 4B, in this embodiment, mixer 10 includes screens 70, 72, and 74 spaced apart from each other and each disposed outwardly from apertures 22. Each screen 70, 72 and 74 may comprise a size of mesh 66 substantially equal to each other or each screen 70, 72 and 74 may have a different size of mesh 66. For example, the size of the mesh 66 of each screen 70, 72 and 74 may be configured corresponding to an outwardly disposed location of each screen 70, 72 and 74 relative to the apertures 22 such that the size of the mesh 66 decreases as a distance between the screen 70, 72 and 74 and the apertures 22 increases. Thus, in operation, each successive screen 70, 72 and 74 produces increased mixing of the substances. For example, in a gas-liquid dissolution application, each screen 70, 72 and 74 produces a smaller bubble size of the gas-liquid mixture as the gas-liquid mixture passes through each successive screen 70, 72 and 74.

FIG. 5 is a diagram illustrating mixer 10 with portions broken away in accordance with another embodiment of the present invention. In this embodiment, mixer 10 includes vanes 80 disposed within an internal area 82 of member 14. For example, vanes 80 are disposed on an interior surface 84 of wall 34. Vanes 80 are formed having a generally helical configuration such that vanes 80 are spirally disposed about the internal area 82 of member 14. In operation, the rotation of mixer 10 in a direction corresponding to the helical direction of vanes 80 provides an increased substance or substance mixture flow rate upwardly into internal area 36 of mixer 10. Thus, vanes 80 provide greater flow rates through mixer 10 at generally lower rotational speeds, thereby increasing the efficiency of mixer 10 and providing a greater range of rotational operating speeds than prior mixers.

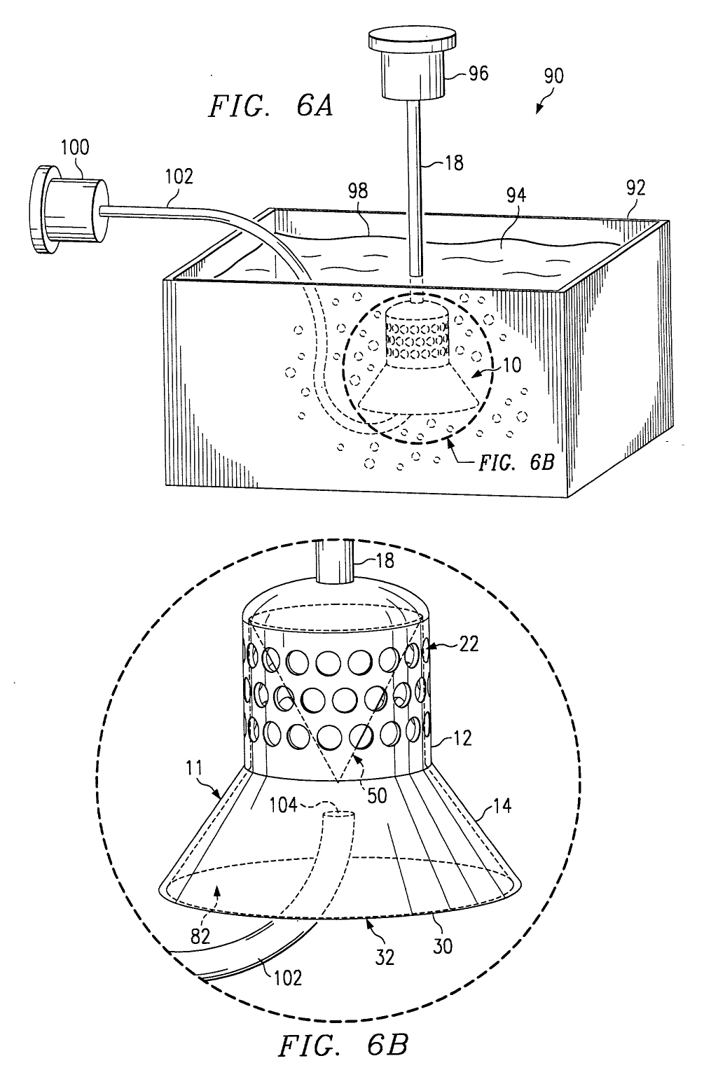

FIGS. 6A and 6B are diagrams illustrating a system 90 incorporating mixer 10 in accordance with an embodiment of the present invention. In this embodiment, the mixed substances include a gas and a liquid, the mixer 10 thereby producing a gas-liquid mixture; however, it should be understood that system 90 and mixer 10 may be used in other substance-mixing applications. Referring to FIG. 6A, mixer 10 is submerged in a reservoir 92 containing a liquid 94. Mixer 10 is suspended within the liquid 94 at a predetermined depth, and a motor 96 provides a rotational force to mixer 10 via shaft 18. As mixer 10 rotates within the liquid 94, mixer 10 becomes a centrifuge-pump, wherein the liquid 94 is drawn upwardly through opening 32 and outwardly through apertures 22.

When mixer 10 is disposed a relatively small distance below a surface 98 of the liquid 94, surface action of the liquid 94 caused by rotation of mixer 10 generates significant low pressure within the internal area 36, thereby drawing both liquid 94 and gas into the internal area 36 to form a corresponding gas-liquid mixture. Thus, the liquid 94 and gas enters through opening 32 of mixer 10 and the gas-liquid mixture is pumped outwardly through apertures 22.

In the embodiment illustrated in FIG. 6A, a pump 100 is provided for delivering a gas through a tube 102 to a location of mixer 10 submerged within the liquid 94. For example, as the depth of the mixer 10 within the liquid 94 increases, vacuum-induced movement of the liquid 94 decreases, thereby resulting in less gas dissolution. Thus, as illustrated in FIG. 6A, a gas may be pumped to a location of the mixer 10 proximate the opening 32 to provide increased gas dissolution into the liquid 94.

Referring to FIG. 6B, the position of tube 102 is illustrated relative to mixer 10. For example, tube 102 extends downwardly into the liquid 94, as illustrated in FIG. 6A. An end 104 of tube 102 is disposed proximate the opening 32 of mixer 10 for discharging the gas in the vicinity of the mixer 10. In the illustrated embodiment, end 104 of tube 102 is disposed within the internal area 82 of member 14. Disposing the end 104 of tube 102 within the internal area 82 of member 14 provides increased gas flow to the mixer 10, thereby resulting in greater gas dissolution. For example, as the liquid 94 is drawn upwardly through opening 32 and into the internal area 82 of member 14, a vacuum pressure is created proximate the end 104 of tube 102, thereby providing an increased rate of gas flow through tube 102. Additionally, disposing the end 104 of tube 102 within the mixer 10 results in a greater volume of the gas being delivered to the mixer 10. A location of end 104 of the tube 102 may be disposed at varying locations within the internal area 82 of member 14; however, the position of the end 104 of tube 102 should be selected to provide minimal obstruction of the liquid 94 entering opening 32. Additionally, it should be understood that end 104 may be positioned below end 30 of member 14.

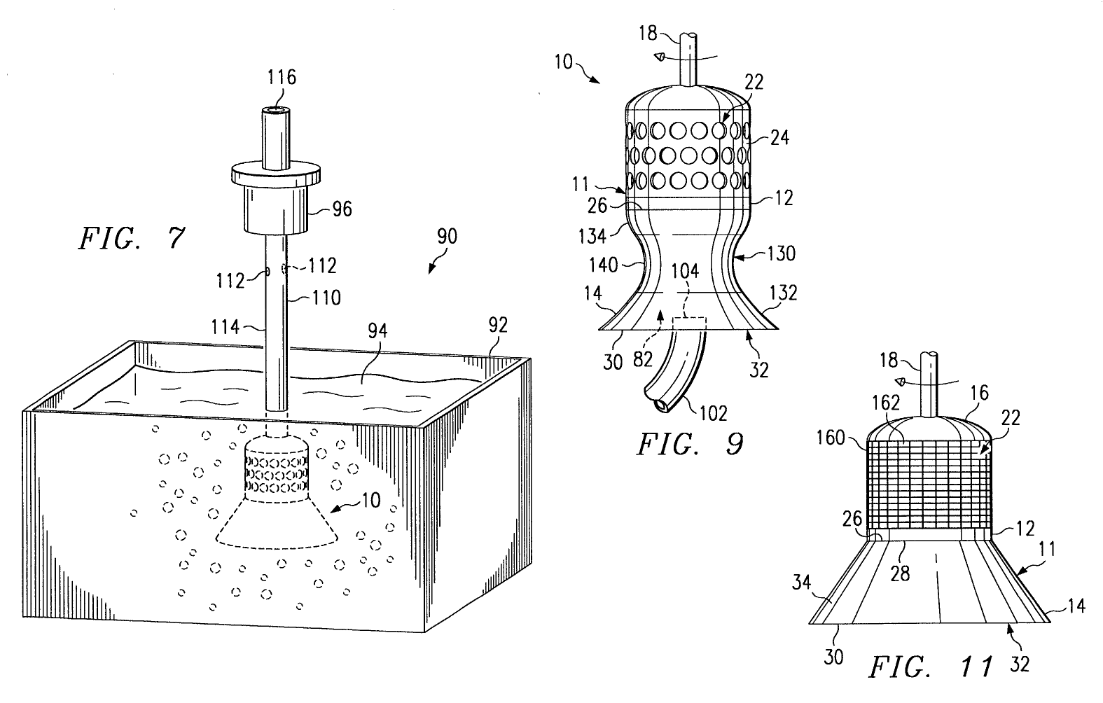

FIG. 7 is a diagram illustrating system 90 incorporating mixer 10 in accordance with another embodiment of the present invention. In this embodiment, the mixed substances include a gas and a liquid, the mixer 10 thereby producing a gas-liquid mixture; however, it should be understood that system 90 and mixer 10 illustrated in FIG. 7 may used in other substance-mixing applications. As illustrated in FIG. 7, mixer 10 comprises a hollow shaft 110 coupled to body 11. The motor 96 is coupled to shaft 110 to provide a rotational force to shaft 110 and body 11. One or more openings 112 are formed in an outer wall 114 of shaft 110 to provide gas communication to the hollow area of shaft 110. However, gas may also be directed downwardly through shaft 110 from an upper end 116 of shaft 110.

In operation, as mixer 10 is rotated, gas is drawn downwardly through shaft 110, via end 116 and/or openings 112, to the internal area 36 of member 12. Additionally, the liquid 94 is drawn upwardly through opening 32 of member 14. For example, as the gas-liquid mixture is pumped outwardly through apertures 22, a vacuum is created within the internal area 36 of member 12, thereby drawing gas downwardly through the hollow shaft 110 and drawing the liquid 94 upwardly through the opening 32.

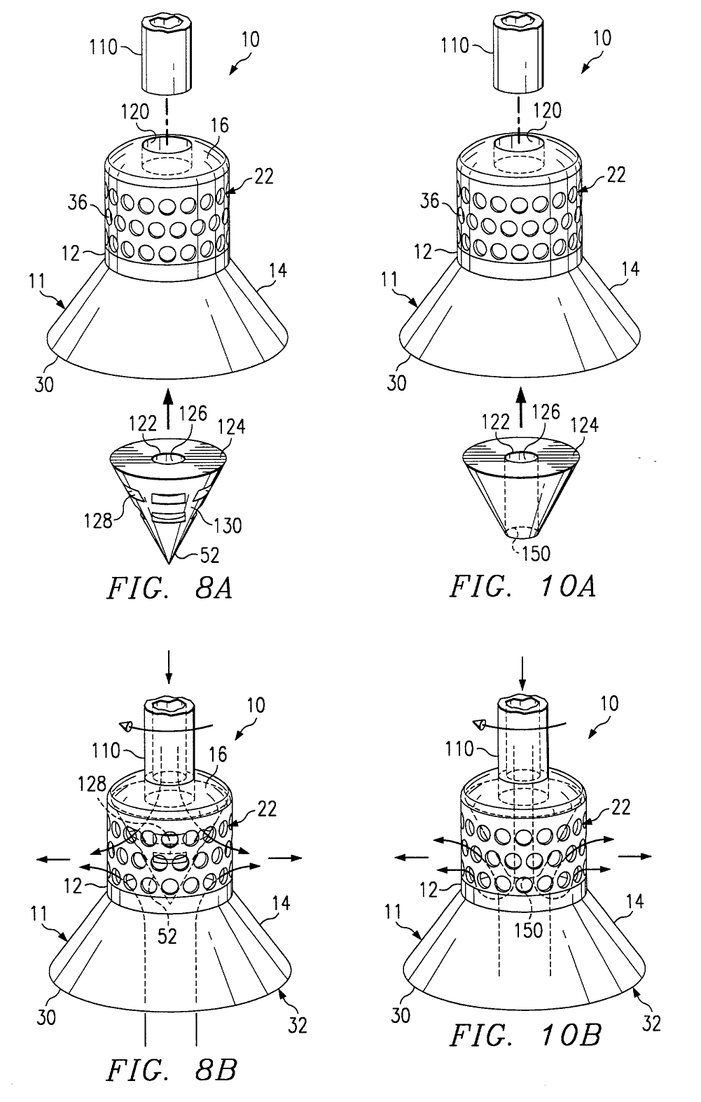

FIGS. 8A-8B are diagrams illustrating the mixer 10 illustrated in FIG. 7 in accordance with an embodiment of the present invention. In this embodiment, mixer 10 includes shaft 110 coupled to end 16 of member 12 and cone 52 disposed within the internal area 36 of member 12. End 16 of member 12 includes an opening 120 to provide gas communication from shaft 110 to the internal area 36 of member 12. Cone 52 includes an opening 122 disposed in an upper surface 124 of cone 52 for receiving the gas from the tube 110 into a hollow internal area 126 of cone 52. Cone 52 also includes apertures 128 disposed in an outer wall 130 of cone 52 to provide gas communication from within the internal area 126 of cone 52 to the internal area 36 of member 12. In the illustrated embodiment, apertures 128 comprise rectangular shaped openings; however, it should be understood that apertures 128 may be configured having other suitable geometric configurations.

In operation, rotation of mixer 10 causes a vacuum pressure within the internal area 36 of member 12, thereby drawing a gas downwardly through shaft 110, openings 120 and 122, into internal area 126 of cone 52, and outwardly through apertures 128. Additionally, the liquid 94 is drawn upwardly through opening 32 of member 14 and mixed with the gas emerging from apertures 128. The gas-liquid mixture in then pumped outwardly through the apertures 22.

FIG. 9 is a diagram illustrating mixer 10 in accordance with another embodiment of the present invention. In this embodiment, member 14 comprises a nozzle 130 disposed between end 30 and end 26 of member 14. Nozzle 130 of member 14 includes a convergent portion 132 extending upwardly from outwardly flared opening 32 and a divergent portion 134 extending upwardly from convergent portion 132 toward end 26 of member 14. In operation, rotation of mixer 10 creates a vacuum pressure within internal area 36 of member 12, thereby drawing a substance or substance mixture upwardly through opening 32 and member 14. As the substance or substance mixture is drawn upwardly within the internal area 82 of member 14, the substance or substance mixture accelerates through nozzle 130, thereby creating a vacuum pressure proximate the opening 32 and increasing a flow rate of the substance or substance mixture upwardly through member 14. For generally very small throat 140 diameters, the vacuum pressure may increase such that cavitation results, thereby increasing a mass transfer between mixed substances. A diameter of a throat 140 of nozzle 130 at an intersection of convergent portion 132 and divergent portion 134 is less than a diameter of opening 32, and the diameter of throat 140 is less than a diameter of end 26 of member 14. A diameter of opening 32 may be greater, less than, or equal to a diameter of end 26 of member 14. As further illustrated in FIG. 9, the end 104 of the tube 102 may also be disposed within the convergent portion 132 of the nozzle 130.

FIGS. 10A and 10B are diagrams illustrating mixer 10 in accordance with another embodiment of the present invention. In this embodiment, cone 52 includes an aperture 150 disposed at the apex 54 of the cone 52. In operation, rotation of mixer 10 causes a vacuum pressure within the internal area 36 of member 12, thereby drawing a substance downwardly through shaft 110, openings 120 and 122, into internal area 126 of cone 52, and outwardly through aperture 150. Additionally, another substance is drawn upwardly through opening 32 of member 14 and mixed with the substance emerging from aperture 150. The substance mixture in then pumped outwardly through the apertures 22.

FIG. 11 is a diagram illustrating mixer 10 in accordance with another embodiment of the present invention. In this embodiment, body 11 includes a screen 160 disposed between ends 16 and 26 of member 12. Screen 160 may be coupled to ends 16 and 26 of member 12 using conventional methods and may be either permanently secured to ends 16 and 26 or removably secured to ends 16 and 26 to provide interchangeability of screen 160, thereby accommodating replacement of screen 160 to correspond with a desired mixing criteria or substance density. For example, in this embodiment, apertures 22 comprise rectangular openings 162 formed by a mesh pattern of screen 160. Thus, in operation, rotation of mixer 10 dispels a substance mixture outwardly through the openings 162 of screen 160. Screen 160 may be selected such that the mesh size forming the openings 162 provides a desired mixing of the substances and accommodates various densities of substances.

Thus, the present invention provides greater efficiency than prior mixers by increasing the substance flow rate through the mixer 10 and providing smoother substance flow patterns around and through the mixer 10. Additionally, a diverter 50 may be disposed within the mixer 10 to efficiently divert substances toward the apertures 22, and vanes 80 may be disposed within the mixer 10 to increase a substance flow rate through the mixer 10. Thus, the present invention may be efficiently operated over a greater range of operational speeds, thereby providing greater efficiency than prior mixers.

Although the present invention and its advantages have been described in detail, it should be understood that various changes, substitutions, and alterations can be made therein without departing from the spirit and scope of the present invention as defined by the appended claims.

What is claimed is:

1. A mixer for producing a substance mixture, comprising:
a rotatable shaft;
a body submersible within a first substance, the body having a first end and a second end, the first end coupled to the shaft, the second end having an outwardly flared opening; and
a plurality of apertures disposed on a wall of the body, wherein rotation of the body draws the first substance and a second substance into an internal area of the body and dispels the substance mixture outwardly through the apertures.

2. The mixer of claim 1, further comprising a vane disposed on an internal surface of the flared opening and operable to enhance flow into the internal area of the body.

3. The mixer of claim 1, wherein the flared opening comprises a substantially straight flared opening.

4. The mixer of claim 1, wherein the flared opening comprises a curved flared opening.

5. The mixer of claim 1, further comprising a cone disposed within the internal area of the body, the cone having an apex disposed downwardly toward the flared opening.

6. The mixer of claim 1, wherein the body comprises a first member coupled to a second member, the apertures disposed on the first member, the flared opening disposed on the second member, and wherein the second member comprises:
a convergent portion extending upwardly from the flared opening, the convergent portion converging to a diameter less than a diameter of the first member; and
a divergent portion extending from the convergent portion upwardly to the first member.

7. The mixer of claim 6, wherein a throat disposed at an intersection of the convergent and divergent portions is sized to produce cavitation within the second member.

8. The mixer of claim 1, further comprising a screen coupled to the body and disposed outwardly from the apertures, the screen operable to enhance mixing of the first and second substances.

9. The mixer of claim 1, wherein the body comprises a first member coupled to a second member, the flared opening disposed on the second member, the first member comprising a screen, wherein rotation of the body dispels the substance mixture through openings formed by the screen.

10. The mixer of claim 1, wherein the shaft comprises a hollow shaft, and wherein rotation of the shaft draws the second substance downwardly within the shaft to the internal area of the body.

11. The mixer of claim 1, further comprising:
a first screen coupled to the body and disposed outwardly from the apertures; and
a second screen disposed outwardly from the first screen, the first and second screens operable to enhance mixing of the first and second substances.

12. A mixer for producing a substance mixture from a first substance and a second substance, comprising:
a first member having a closed first end and an open second end, the first member having a plurality of openings disposed in an outer wall thereof;
a rotatable shaft coupled to the first end of the first member;
a second member having a first end and a second end, the first end of the second member coupled to the second end of the first member, an outwardly flared opening disposed on the second end of the second member, and wherein rotation of the first and second members draws the first and second substances into an internal area of the first member and dispels the substance mixture outwardly through the apertures.

13. The mixer of claim 12, further comprising a cone disposed within the internal area of the first member, the cone having an apex disposed downwardly toward the second member.

14. The mixer of claim 13, further comprising a screen disposed outwardly from the apertures and operable to enhance mixing of the first and second substances.

15. The mixer of claim 13, wherein the flared opening comprises a curved flared opening.

16. The mixer of claim 13, wherein the second member comprises:
a convergent portion extending upwardly from the second end of the second member; and
a divergent portion extending upwardly from the convergent portion to the first end of the second member.

17. The mixer of claim 16, wherein a diameter at an intersection of the convergent and divergent portions is less than a diameter of the first end of the second member.

18. The mixer of claim 13, further comprising a plurality of vanes disposed on an internal surface of a wall of the second member, the vanes operable to increase a flow rate into the internal area of the first member.

19. The mixer of claim 12, further comprising a plurality of screens disposed outwardly from the apertures, each screen having a different mesh size, each of the screens operable to enhance mixing of the first and second substances.

20. A mixer for producing a substance mixture, comprising:
a rotatable shaft;
a body submersible within a first substance, the body having a first end coupled to the shaft, the body having an open second end;
a cone disposed within an internal area of the body, the cone having an apex directed downwardly toward the second end; and
a plurality of apertures disposed on a wall of the body, wherein rotation of the body draws the first substance and a second substance into the internal area of the body and dispels the substance mixture outwardly through the apertures.

21. The mixer of claim 20, wherein the body comprises a first member coupled to a second member, the first member coupled to the shaft, and wherein the second member comprises:
a convergent portion; and
a divergent portion extending upwardly from the convergent portion to an intersection between the first and second members.

22. The mixer of claim 21, wherein a diameter at an intersection of the convergent and divergent portions is less than a diameter at the intersection between the first and second members.

23. The mixer of claim 22, wherein the convergent portion comprises a substantially straight outwardly flared opening.

24. The mixer of claim 23, wherein the convergent portion comprises a curved outwardly flared opening.

25. The mixer of claim 20, further comprising a screen disposed outwardly from the apertures, the screen operable to enhance mixing of the first and second substances.

26. The mixer of claim 20, further comprising a plurality of vanes disposed on an internal surface of the wall of the body, the vanes operable to increase a flow rate into the internal area of the body.

27. A mixer for producing a substance mixture, comprising:
a rotatable shaft;
a body submersible within a first substance, the body having a first end and a second end, the first end coupled to the shaft, the second end having an opening;
a plurality of apertures disposed on a wall of the body, wherein rotation of the body draws the first substance and a second substance into an internal area of the body and dispels the substance mixture outwardly through the apertures; and
a screen disposed outwardly from the apertures, the screen operable to enhance mixing of the first and second substances as the substance mixture passes through the screen.

28. The mixer of claim 27, wherein a diameter of the opening is greater than a diameter of the internal area of the body.

29. The mixer of claim 28, further comprising a cone disposed within the internal area of the body, the cone having an apex directed downwardly toward the opening.

30. The mixer of claim 28, wherein the shaft comprises a hollow shaft, and wherein rotation of the shaft draws the second substance downwardly within the shaft to the internal area of the body.

31. The mixer of claim 27, wherein the body comprises a first member coupled to a second member, the apertures disposed on the first member, the opening disposed on the second member, and further comprising a plurality of vanes disposed on an internal surface of a wall of the second member, the vanes operable to enhance flow into the internal area.

32. The mixer of claim 31, wherein the vanes comprise helically configured vanes formed corresponding to a direction of rotation of the body.

33. The mixer of claim 27, wherein the body comprises a first member coupled to a second member, the apertures disposed on the first member, the opening disposed on the second member, and wherein the second member comprises:
a convergent portion extending upwardly from the opening; and
a divergent portion extending upwardly from the convergent portion to an intersection between the first and second members.

34. A mixer for producing a substance mixture, comprising:
a rotatable shaft;
a body submersible within a first substance, the body having a first end coupled to the shaft, the body having an open second end;
a plurality of apertures disposed on a wall of the body, wherein rotation of the body draws the first substance and a second substance into an internal area of the body and dispels the substance mixture outwardly through the apertures; and
a plurality of vanes disposed on an internal wall of the body between the apertures and the opening, the vanes operable to enhance a flow rate of the first substance into the internal area of the body.

35. The mixer of claim 34, wherein the vanes comprise helically configured vanes formed corresponding to a direction of rotation of the body.

36. The mixer of claim 34, wherein a diameter of the open second end is greater than a diameter of the internal area of the body adjacent the apertures.

37. The mixer of claim 34, further comprising a plurality of screens disposed outwardly from the apertures, each of the screens having a different mesh size, the screens operable to enhance mixing of the first and second substances.

38. The mixer of claim 34, wherein the body comprises a first member coupled to a second member, the apertures disposed on the first member, the open second end disposed on the second member, and wherein the vanes are formed on an internal wall of the second member.

39. The mixer of claim 38, wherein the open second end comprises an outwardly flared opening.

40. The mixer of claim 38, wherein the vanes comprise helically configured vanes formed corresponding to a direction of rotation of the body.

41. The mixer of claim 40, further comprising a cone disposed within an internal area of the first member, the cone having an apex disposed downwardly toward the second member.

42. The mixer of claim 34, wherein the second end comprises:
a convergent portion extending upwardly from the open second end; and
a divergent portion extending upwardly from the convergent portion toward the apertures, a diameter at an intersection of the convergent and divergent portions less than a diameter of the body adjacent the apertures.

43. The mixer of claim 42, wherein the intersection of the convergent and divergent portions is sized to produce cavitation within the body.

44. A method for producing a substance mixture, comprising:
disposing a mixer into a first substance, the mixer having a body and a shaft, the body having a first end coupled to the shaft, the body having an open second end;
rotating the shaft to draw the first substance into an internal area of the body through the open second end, rotating the shaft further drawing a second substance into the internal area of the body; and
diverting the substance mixture from the internal area through a plurality of apertures formed in a wall of the body via a diverter disposed within the internal area.

45. The method of claim 44, wherein diverting the substance mixture via a diverter comprises diverting the substance mixture via a cone disposed within the internal area of the body, the cone having an apex directed downwardly toward the open second end.

46. The method of claim 44, further comprising enhancing mixing of the first and second substances by passing the substance mixture through a screen disposed outwardly from the apertures.

47. The method of claim 44, wherein disposing a mixer in a first substance comprises disposing a mixer in a first substance, the mixer having a body with an open second end, the open second end comprising an outwardly flared opening.

48. The method of claim 44, further comprising enhancing a flow rate into the internal area of the body via vanes formed on an internal wall of the body.

49. The method of claim 48, wherein the vanes comprise helically configured vanes, and wherein rotating comprises rotating the shaft in a direction corresponding to the helical direction of the vanes.

50. The method of claim 44, further comprising enhancing mixing of the first and second substances by passing the substance mixture through a plurality of screens disposed outwardly from the apertures, each of the screens having a different mesh size.

51. The method of claim 44, wherein rotating the shaft to draw the first substance into an internal area of the body comprises:
drawing the first substance into a convergent portion of the body; and
drawing the first substance into a divergent portion of the body from the convergent portion, wherein a diameter of an intersection of the convergent and divergent portions is less than a diameter of the body adjacent the apertures.

52. The method of claim 51, wherein drawing the first substance into the convergent and divergent portions produces cavitation in the first substance.

53. A method for producing a substance mixture, comprising:
disposing an mixer into a first substance, the mixer having a body and a shaft, the body having a first end coupled to the shaft, the body having a second end formed with an outwardly flared opening;
rotating the shaft to draw the first substance into an internal area of the body through the flared opening, rotating the shaft further drawing a second substance into the internal area of the body; and
passing the substance mixture from the internal area through a plurality of apertures formed in a wall of the body.

54. The method of claim 53, further comprising enhancing mixing of the first and second substances by passing the substance mixture emerging from the apertures through a screen disposed outwardly from the apertures.

55. The method of claim 53, wherein disposing a mixer into a first substance comprises disposing a mixer into a first substance, the body of the mixer having a second end formed with a substantially straight flared opening.

56. The method of claim 53, wherein disposing a mixer into a first substance comprises disposing a mixer into a first substance, the body of the mixer having a second end formed with a curved flared opening.

57. The method of claim 53, further comprising enhancing mixing of the first and second substances by passing the substance mixture emerging from the apertures through a plurality of screens disposed outwardly from the apertures, each of the screens having a different mesh size.

58. The method of claim 53, wherein rotating the shaft further comprises drawing the second substance downwardly through a hollow shaft to the internal area of the body.

59. The method of claim 53, further comprising enhancing a flow rate of the first substance into the internal area of the body via vanes formed on an internal wall of the body.

60. The method of claim 59, wherein the vanes comprise helically configured vanes, and wherein rotating comprises rotating the shaft in a direction corresponding to the helical direction of the vanes.

61. The method of claim 53, wherein rotating the shaft to draw a first substance into an internal area of the body comprises:
drawing the first substance into a convergent portion of the body; and
drawing the first substance into a divergent portion of the body from the convergent portion, wherein a diameter of an intersection of the convergent and divergent portions is less than a diameter of the body adjacent the apertures.

62. A system for producing a substance mixture, comprising:
a mixer disposed within a first substance;
a motor operable to provide a rotational force to the mixer; and
a tube operable to provide a second mixture to an opening of the mixer, the tube having an end disposed within an internal area of the mixer.

63. The system of claim 62, wherein the mixer comprises:
a first member having a plurality of apertures; and
a second member coupled to the first member, the second member having an open end operable to receive the second mixture from the end of the tube.

64. The system of claim 63, wherein the end of the tube is disposed within an internal area of the second member.

65. The system of claim 62, wherein the mixer comprises an outwardly flared opening, and wherein the end of the tube is disposed within the outwardly flared opening.

66. The system of claim 62, wherein the mixer comprises:
a first member having a plurality of apertures; and
a second member coupled to the first member, the second member having a nozzle, and wherein the end of the tube is disposed with a convergent portion of the nozzle.

67. The system of claim 62, further comprising a pump coupled to the tube and operable to pump the second substance through the tube to the mixer.

68. The system of claim 62, wherein the mixer comprises a diverter operable to the substance mixture toward a plurality of apertures of the mixer, and wherein the end of the tube is disposed within the mixer below the diverter.
